(19) United States
(12) Patent Application Publication
(10) Pub. No.: US 2015/0310125 A1
(43) Pub. Date: Oct. 29, 2015

(54) Dynamic Custom Style Sheet Isolation

(71) Applicants: Barak Kinarti, Kfar Saba (IL); Nati Ari, Kadima-Zoran (IL)

(72) Inventors: Barak Kinarti, Kfar Saba (IL); Nati Ari, Kadima-Zoran (IL)

(21) Appl. No.: 14/264,988

(22) Filed: Apr. 29, 2014

(51) Int. Cl. G06F 17/30; G06F 17/21

(52) U.S. Cl. CPC G06F 17/30905; G06F 17/212

(57) ABSTRACT

A system is programmed to execute a method that includes loading a cascaded style sheet (CSS) file for a web document into a memory of a computer system and appending a selector to a rule of the loaded CSS file to be applied to a selected document object management (DOM) element.

### BACKGROUND

Cascading style sheets (CSS) are used to define presentation rules and properties for formatting and rendering web documents. The presentation rules generally apply to elements in the entire web document.

### SUMMARY

A method includes loading a cascaded style sheet (CSS) file for a web document into a memory of a computer system and appending a selector to a rule of the loaded CSS file to be applied to a selected document object management (DOM) element.

A machine readable storage device has instructions for execution by a processor to perform loading a cascaded style sheet (CSS) file for a web document into a memory of the machine, and appending a selector to a rule of the loaded CSS file to be applied to a selected document object management (DOM) element.

A system includes a processor and a memory device coupled to the processor and having a program stored thereon for execution by the processor to dynamically load a cascading style sheet (CSS) set of rules for a web document, identify a document object management (DOM) element selector appended to a rule in the set of rules, and apply the rule to only the DOM element identified by the selector to render the web document.

### BRIEF DESCRIPTION OF THE DRAWINGS

FIG. 1 is a flowchart illustration of adding a unique ID to a cascading style sheet (CSS) rule according to an example embodiment.

FIG. 2 is a flowchart illustration of editing a (CSS) rule to add a unique ID according to an example embodiment.

FIG. 3 is a flowchart illustration of applying a CSS rule having a unique ID according to an example embodiment.

FIG. 4 is a block diagram of a computer system for implementing one or more methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

In various embodiments, narrow cascading style sheets (CSS) may be applied on specific document object management (DOM) elements. Selected rules may be isolated on specific DOM elements or multiple DOM elements without affecting other DOM elements on a page. By isolating CSS style rules to specified DOM elements, potentially harmful style rules are not propagated to other DOM elements and affecting an entire page.

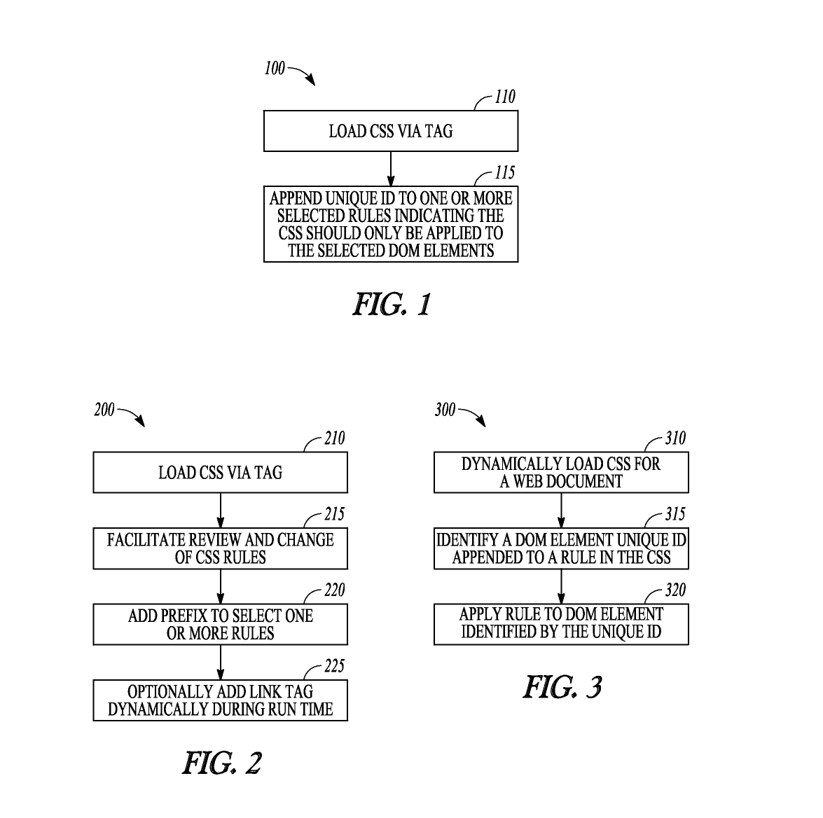

In one example illustrated in flowchart form at 100 in FIG. 1, a user wants to load a CSS dynamically and apply the rules of the CSS only on specific DOM element such as the footer/header of the page with a selector, such as a unique ID, class selector or ID, attribute selector, or media query which may define that a CSS rule will be applied only on a certain device or screen size for example. If the user/developer loads the CSS file as previously done, then all of the CSS rules will affect the entire page. Instead, the CSS is loaded at 110 and the footer/header unique ID is appended at 115 to one or more selected rules of the loaded CSS in a manner indicating that the CSS should only be applied to the specific DOM element.

The same above scenario may be applied with a different type of selector, such as a generic CSS class instead of a unique ID. The CSS rule may be applied for both the header and the footer. In a portal scenario, the portal may have multiple widgets on an HTML page. Widgets are objects attached to page elements that supply services for managing lifetime, state, inheritance, theming, and communication with other widgets or JavaScript objects. A portal may have multiple widgets on the HTML page. Widgets are embedded on the page. i.e. each widget is wrapped in a DIV element with specific unique ID. A DIV element in DOM is an object having types of members including events, methods, and properties.

If a widget will load a CSS file, it will affect the entire site and all the widgets. However, with dynamic CSS loading, each widget loads the CSS file, and the specific unique ID is added to each CSS rule. An example CSS file name is illustrated prior to insertion of the widget ID on two rules defining an “OK” button and a “CANCEL” button for a user interface: mystylesheetName.css

.button-ok{

background-color:green;
color: white;

}
.button-cancel{

background-color:red;
color: white;

}

The following example scenarios illustrate the dynamic CSS utilizing the widget ID to control the beginning and ending of the CSS application to one or more DOM elements. In this example, the CSS rules are the same elements as above, an “OK” button and a “CANCEL” button. DOM elements (a DIV element for example) have a widget with the id “widgetID1”. The CSS file is loaded in one of the below options, appending prefix widgetID1 to each rule. The mystylesheetName.css content will be changed as follows:

# widgetID1 .button-ok{

background-color:green;
color: white;

}
#widgetID1 .button-cancel{

background-color:red;
color: white;

}

Several different ways of loading a CSS file into a page and appending a prefix to each CSS rule are now described.

In a first example embodiment, a CSS file is dynamically loaded via an AJAX request by parsing the CSS rules and then adding a prefix to one or more selected rules.

In a second example embodiment as illustrated in flowchart form at 200 in FIG. 2, a CSS may be loaded via a<link> tag at 210. After loading, a programmer may review the CSS rules and change them at 215. An editor may be used to facilitate such review and changing. The following example illustrates looking for mystylesheetName.css file and performing the change. Then the prefix is added via the editor to each of the selected one or more rules:

function changeRules( ) {

var results = ‘’,

log = ‘’;

if (!document.styleSheets) {

return;

}
for (var i = 0; i < document.styleSheets.length; i++) {

if (/mystylesheetName.css/i.test(document.styleSheets[i].href)) {

changeSheet(document.styleSheets[i]);

}

}
function changeSheet(sheet) {

var count = 0;
if (sheet && sheet.cssRules) {

for (var j = 0, 1 = sheet.cssRules.length; j < 1; j++) {

if (!sheet.cssRules[j].selectorText) continue;
count += sheet.cssRules[j].selectorText.split(‘,’).length;
//Here we append the prefix widgetID to the rule
sheet.cssRules[j].selectorText = “#widgetID” +

sheet.cssRules[j].selectorText;

console.warn(sheet.cssRules[j].selectorText);

}

}

}

}

changeRules( );

In a third example, the same process is followed as in the second example, and in addition, the link tag is optionally added dynamically during run time at 225 as illustrated in FIG. 2. For example:

jQuery(‘head’).append(‘<link href=“http://example.stie/mystylesheetName.css”’); run the changeRules function.

FIG. 3 is a flowchart illustration of a method 300 of using a CSS according to an example embodiment. At 310, the CSS is dynamically loaded for a web document. Method 300 at 315 then identifies a document object management (DOM) element unique ID appended to a rule in the set of rules. At 320, the rule is applied to only the DOM element or set of DOM elements identified by the unique ID to render the web document.

Previously, CSS files could be loaded into an existing site, but such files could then potentially influence and alter the entire site. The currently described embodiments instead facilitate designation of a very specific scope within a site, which would be affected by the introduction of the CSS file, leaving the remaining portions of the site untouched and uninfluenced. An ability is provided to establish any scope (portions of a site) that will be affected by the CSS file.

Furthermore, the ability to establish such scopes and thus isolate that which can be affected by the CSS file, in the broad picture allows establishment of hierarchies such that different portions would be affected by different CSS files, without having to deal with conflicts, as described in the embedded widget scenario.

Up until the introduction of the embodiments described, the only method of truly isolating the influence of a CSS file was the utilization of iframes, which in turn are extremely expensive performance wise, and usually developers prefer to avoid using iframes whenever possible.

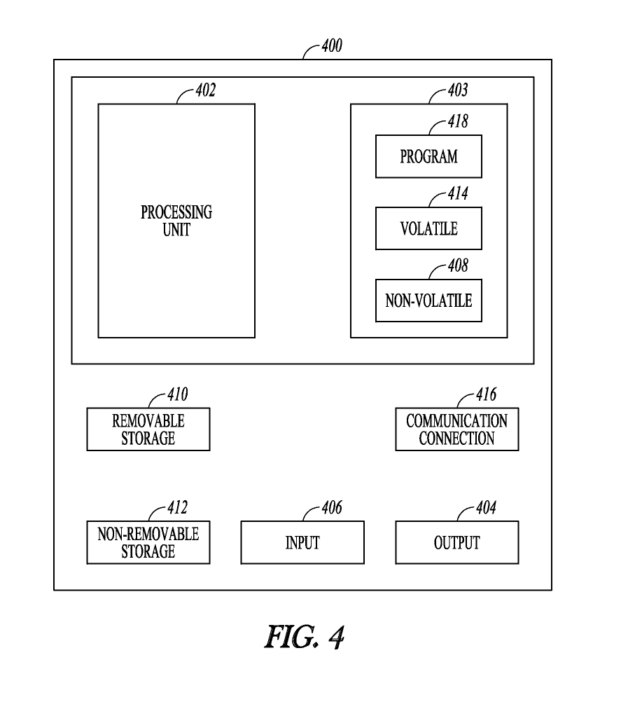

FIG. 4 is a block schematic diagram of a computer system 400 to implement a controller according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 400, may include a processing unit 402, memory 403, removable storage 410, and non-removable storage 412. Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 400 may include or have access to a computing environment that includes input 406, output 404, and a communication connection 416. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### Examples

1. A method comprising:

loading a cascaded style sheet (CSS) file for a web document into a memory of a computer system; and

appending a selector to a rule of the loaded CSS file to be applied to a selected document object management (DOM) element.

2. The method of example 1 wherein the selector comprises a unique ID appended as a prefix to the rule.

3. The method of example 2 wherein the unique ID is appended to multiple rules and only applies to such multiple rules.

4. The method of any of examples 2-3 wherein the selector is at least one of widget IDs, class selectors, attribute selectors, and media queries.

5. The method of example 4 wherein the widget comprises an object to attach to DOM elements.

6. The method of any of examples 1-5 and further comprising adding a link tag dynamically during run time of the rule.

7. The method of any of examples 1-6 wherein the DOM element is a footer of the web document.

8. The method of example 7 wherein the DOM element further comprises a header of the web document.

9. The method of any of examples 1-8 wherein the DOM element is a button.

10. The method of any of examples 1-9 wherein the CSS file is dynamically loaded responsive to a request, the CSS rules are parsed, and the selector comprises a unique ID added as a prefix.

11. A machine readable storage device having instructions for execution by a processor of the machine to perform operations comprising:

loading a cascaded style sheet (CSS) file for a web document into a memory of the machine; and

appending a selector to a rule of the loaded CSS file to be applied to a selected document object management (DOM) element.

12. The storage device of example 11 wherein the selector comprises a unique ID appended as a prefix to the rule.

13. The storage device of example 12 wherein the unique ID is an ID of an object to attach to DOM elements.

14. The storage device of any of examples 11-13 wherein the instructions cause the machine to add a link tag dynamically during run time of the rule.

15. The storage device of any of examples 11-14 wherein the DOM element is a button.

16. The storage device of any of examples 11-15 wherein the CSS file is dynamically loaded by the processor responsive to a request, the CSS rules are parsed, and the selector comprises a unique ID added as a prefix.

17. A system comprising:

a processor; and

a memory device coupled to the processor and having a program stored thereon for execution by the processor to:

dynamically load a cascading style sheet (CSS) set of rules for a web document;

identify a document object management (DOM) element selector appended to a rule in the set of rules; and

apply the rule to only the DOM element identified by the selector to render the web document.

18. The system of example 17 wherein the unique ID is appended as a prefix to the rule.

19. The system of any of examples 17-18 wherein the DOM element is a header or a footer of the web document.

20. The system of any of examples 17-19 wherein the CSS file is dynamically loaded by the processor responsive to a request, the CSS rules are parsed, and the selector comprises a unique ID that is a prefix to the rule.

21. The method of claim 1 wherein the wherein the rule is only applied to the selected DOM element.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
loading a cascaded style sheet (CSS) file for a web document into a memory of a computer system; and
appending a selector to a rule of the loaded CSS file to be applied to a selected document object management (DOM) element.

2. The method of claim 1 wherein the selector comprises a unique ID appended as a prefix to the rule.

3. The method of claim 2 wherein the unique ID is appended to multiple rules and only applies to such multiple rules.

4. The method of claim 1 wherein the selector comprises at least one of widget IDs, class selectors, attribute selectors, and media queries.

5. The method of claim 4 wherein the widget comprises an object to attach to DOM elements.

6. The method of claim 1 and further comprising adding a link tag dynamically during run time of the rule.

7. The method of claim 1 wherein the DOM element is a footer of the web document.

8. The method of claim 7 wherein the DOM element further comprises a header of the web document.

9. The method of claim 1 wherein the DOM element is a button.

10. The method of claim 1 wherein the CSS file is dynamically loaded responsive to a request, the CSS rules are parsed, and the selector comprises a unique ID added as a prefix.

11. A machine readable storage device having instructions for execution by a processor of the machine to perform operations comprising:
loading a cascaded style sheet (CSS) file for a web document into a memory of the machine; and
appending a selector to a rule of the loaded CSS file to be applied to a selected document object management (DOM) element.

12. The storage device of claim 11 wherein the selector comprises a unique ID appended as a prefix to the rule.

13. The storage device of claim 12 wherein the unique ID is an ID of an object to attach to DOM elements.

14. The storage device of claim 11 wherein the instructions cause the machine to add a link tag dynamically during run time of the rule.

15. The storage device of claim 11 wherein the DOM element is a button.

16. The storage device of claim 11 wherein the CSS file is dynamically loaded by the processor responsive to a request, the CSS rules are parsed, and the unique ID is added as a prefix.

17. A system comprising:
a processor; and
a memory device coupled to the processor and having a program stored thereon for execution by the processor to:
dynamically load a cascading style sheet (CSS) set of rules for a web document;
identify a document object management (DOM) element selector appended to a rule in the set of rules; and
apply the rule to only the DOM element identified by the selector to render the web document.

18. The system of claim 17 wherein the selector comprises a unique ID appended as a prefix to the rule.

19. The system of claim 17 wherein the DOM element is a header or a footer of the web document.

20. The system of claim 17 wherein the CSS file is dynamically loaded by the processor responsive to a request, the CSS rules are parsed, and selector comprise a unique ID that is a prefix to the rule.
